(19) United States
(12) Patent Application Publication
(10) Pub. No.: US 2003/0135327 A1
(43) Pub. Date: Jul. 17, 2003

(54) Low cost inertial navigator

(76) Inventors: Seymour Levine, Culver City, CA (US); Kevin Cotton Baxter, Santa Clarita, CA (US); Ken Scott Fisher, Los Angeles, CA (US)

Correspondence Address: Ken Fisher, 5528 Vineland Ave., North Hollywood, CA, 91601, US

(21) Appl. No.: 10/044,802

(22) Filed: Jan. 11, 2002

(51) Int. Cl. G01C 21/00

(52) U.S. Cl. 701/220; 701/213; 342/357.06

(57) ABSTRACT

A low-cost, portable, strap-down, navigation system including: an Inertial Navigation System (INS); a GPS receiver; and a 3-Axis Magnetometer (MAG). A microprocessor controls and filters the data from the INS, GPS and MAG. In a preferred embodiment the system provides an indication of: True Heading; 3-D Position; 3-D Velocity; 3-D Acceleration; 3-D Attitude; and 3-D Angular Rate. A filter weighs the trustworthiness of each sensor, favoring the GPS and MAG sensors for relatively low rate movements and steady state conditions and the INS sensors for transient movements.

### BACKGROUND

1. Field of the Invention

The present invention relates generally to the field of navigational systems. More particularly, but not by way of limitation, the present invention relates to a portable, low-cost, navigational system which utilizes a plurality of sensors to provide accurate attitude, position, rate, and acceleration of a craft.

2. Background of the Invention

Before beginning a general discussion of the background of the invention, it may be helpful to provide the definitions of a number of terms used herein. While, generally speaking, these terms should be familiar to those skilled in the art, certain terms may be used in a somewhat broader sense with regard to the present invention than is otherwise customary.

“GNSS”

Global navigation satellite systems (GNSS) are now well known in the art. Such multiple satellite systems are employed for a determination of the geocentric position of mobile units, such as water and land vehicles, space and aircraft, and survey equipment, to name a few. In aircraft, GNSS systems are being utilized for navigation, flight control, and airspace control. By way of example and not limitation, one such GNSS is the Global Positioning System (GPS) launched and maintained by the United States.

“Satellite”

As used herein, is intended to include a combination of satellites, including pseudolites or equivalents of pseudolites (e.g., differential systems). Pseudolites are generally ground-based transmitters, which are synchronized with GPS time. Pseudolites are useful in situations where GPS signals from an orbiting satellite might be unavailable, such as tunnels, mines, airports, buildings or other enclosed areas.

“INS”

Inertial navigation systems and sensors, also known as an Inertial Measurement Unit (IMU), Inertial Navigation Unit (INU) or Inertial Reference Unit (IRU). Typically an INS provides three dimensions of position, velocity & acceleration, roll & pitch attitudes, heading, roll & pitch attitude rates, and yaw/heading rate. It should be noted that an INS typically only provides such information relative to an initial point (IP) or to an externally provided absolute point, such as a known “surveyed point” on an airport, or from a GPS receiver. INS system configurations may be classified into two major categories; inertial stabilized gimbals or strap-down systems. In the former category, the inertial sensors (gyroscopes and accelerometers) are mounted on a stabilized platform to de-couple the sensors from any rotational motion of the vehicle or probe in which they are installed. This allows for gyroscopes with a relatively low dynamic range and moderately accurate scale factors to be used. In the strap-down configurations, the inertial sensors are attached rigidly (or via shock isolation mounts) to the vehicle (or hand-held) causing the gyroscopes to be subjected to the maximum turn rates of the vehicle. Therefore, gyroscopes (e.g., MEMS, laser, and fiber optic inertial sensors) used in strap-down systems require a much larger dynamic range. In strap-down systems, the mechanical complexity of platform systems (the mechanical gimbals structure which supports the stable platform allowing its isolation from the angular motion of the vehicle and the associated components-slip rings, resolves and torque motors) are discarded at the expense of a substantial increase in computational complexity.

“GPS”

Although the methods and apparatus of the present invention will be described with reference to the United States Global Positioning Satellite (GPS) system, it should be appreciated that the term “GPS” also includes signals from alternative satellite positioning systems (e.g., GNSS, GLONASS, Galileo, MSAS, EGNOS, Look-Down, etc.), and positioning sensors. The teachings are equally applicable to positioning systems, which utilize pseudolites (or a combination of satellites and pseudolites) and also applicable to Ultra-wideband (UWB) positioning schemes (e.g., UWB radar).

“GPS Attitude”

GPS attitude refers to schemes by which a vehicle's heading, pitch, and roll are estimated from calculated GPS velocity vectors. Single antenna and/or single receiver GPS-only systems are limited to providing track data, namely the angle between the vehicles north-south and east-west velocities (no accurate heading or attitude readings). In such a system, track angle can only be used for vehicle guidance when the vehicle is traveling at reasonable speed (with many systems experiencing a delay between a craft's change of direction and the GPS's recognition of such a change). When the speed gets low, or zero, the GPS position fluctuates based on receiver, atmospheric noise, and intentional errors (e.g., US Dept of Defense Selective Availability), thus any indication of track angle is, at best, unreliable, otherwise non-existent. At low vehicle speeds the GPS velocity, which is derived from measurements in the changes in GPS position, also vary widely. Thus, the GPS track angle becomes unsuitable for very low speed piloting or as an indicator of the vehicle's pointing angle with respect to north. In a similar way, the tilt angles of the vehicle, derived by GPS, are also unsuitable for the piloting function. Schemes for detecting attitude/heading using only GPS signals do exist, using a minimum of two antennae, and attitude generally requires at least three or more antennae (and other specialized circuitry and/or receivers), with the most accurate schemes using antennae spaced far apart. This approach can severely limit the portability and fast setup time. The multi receiver and/or multi antenna systems are generally a much more expensive technology compared to single antenna/single GPS receiver systems, and are still at risk for signal brownouts and dropouts.

“INS/GPS”

Means the blending of INS and GPS data. This combination provides improved and highly accurate position and altitude information, including attitude and heading. The blending of INS and GPS data can be accomplished via an optimum filter. A particular, and well known, manifestation of this filtering process is known as Kalman filtering, in which the filter feedback gains are selected in an optimal manner with a view towards minimizing the covariances of the errors.

“MEMS”

Micro, or Micro-machined, Electro Mechanical Systems are made by a relatively new construction technique, which allows components to be miniaturized. The inertial instruments made by using these techniques typically are low cost but generally have moderate to poor performance accuracy.

“Gyros”

Gyroscopic devices are typically found in an INS and are used to sense vehicle rotation, or rotation rates. Such devices include: mechanical rotating mass devices; optical devices such as ring laser gyros (RLGs) devices or fiber optic gyros (FOGs) or MEMS rate gyros which are generally based on a vibrating arc, which mimics the actions of traditional rate gyros. MEMS gyros are characteristically very small, use low power, and may be housed in a solid-state type package. Unfortunately, MEMS devices typically exhibit drift at a rate many times that of their counterparts. Drift may also arise from changes in temperature. Regardless, drift results in an error in rotation position or rotational rate that, if left uncorrected, results in erroneous information from the INS. Thus a gyro must periodically be re-referenced to overcome the effects of drift. Because of the small masses involved in such a small package, MEMS devices tend to be exceptionally rugged and reliable rate gyros.

“Accelerometers”

These are devices used in INS and sense vehicle accelerations. These are electromechanical devices that sense acceleration by its force on a mass. These can also be constructed as a miniature device by utilizing MEMS technology. This invention can use MEMS accelerometers, which are available in at least three varieties, piezoelectric, torque-feedback and strain gauge. The piezoelectric versions are very inexpensive but are extremely sensitive to temperature and generally AC coupled. This means they sense changes but are not well suited to static situations. The latest versions of piezo technology are DC coupled but have many limitations. The torque-feedback accelerometers are accurate but expensive. The preferred embodiment of the current invention uses the stain gauge versions of MEMS accelerometers. The strain gauge's current version is very small, very stable, reasonably inexpensive, and is DC coupled. DC coupling allows accurate readings even when not moving. Inclinometers or Torroid spirit levels could be also used as accelerometers or as method of determining attitude in this invention. Changes in software would be required if these devices were to be interchanged with traditional accelerometers. This modification would be rudimentary for one skilled in the art.

“Magnetometers”

These are devices that can give heading by sensing the direction of the earth's magnetic field. They have recently undergone miniaturization and minimization (e.g. MEMS). Traditional magnetometers have been copper wire, wound over iron cores to make transformers that could sense the earth's magnetic field. Miniaturization has obviously reduced the size, but also the cost and power required to implement a 3-axis magnetometer. Present miniature magnetometers have shrunk to surface-mount sized parts, which are soldered to circuit boards, with no other mounting hardware required. These miniature magnetometers have no major disadvantage when compared to traditional magnetometers.

“Barometric Sensor”

Barometric altitude is a method of determining a close approximation of actual altitude. This requires a barometric sensor, which has traditionally consisted of a mechanical chamber, which expands, and contracts with the varying atmospheric pressures associated with changes in altitude. This chamber is mechanically connected via levers and gears to a dial or gauge, which shows a numeric representation of altitude. This mechanical device is known as an altimeter. This is an over simplification, but it points to the complexity and fragility of such a device. MEMS devices, on the other hand, are effectively tiny diaphragms with integral strain gauges, which measure the barometric pressure changes. There are no moving parts other than the bowing of this diaphragm. This allows these parts to be extremely small, inexpensive, rugged, and able to withstand barometric shocks which would ruin a traditional aircraft altimeter. These sensors come in many varieties, but a temperature corrected version would be the most desirable without a large cost penalty.

“Heading or True Heading”

Is the angle between a surveyed reference line from the front of a level vehicle to its back with respect to geodetic north. For example, on a level aircraft, it is the surveyed line between the nose and tail of the aircraft with respect to geodetic north. When the nose of an aircraft is pointing in direction of geodetic north it's heading is zero degrees. When the nose is pointing in the easterly direction it's heading is 90 degrees. The heading of a vehicle is an indicator of the direction a vehicle will take when operated by its own engine thrust. Thus, at zero or low speeds it represents the intended course of a vehicle. As such, it is exceedingly important in preventing ground incursions at airports where multiple aircraft are closely spaced on controlled-runways.

“Magnetic Heading”

Is the angle between a surveyed reference line from the front of a level vehicle to its back with respect to the earth's magnetic north pole. For example on a level aircraft it is the surveyed line between the nose and tail of the aircraft with respect to the earth's magnetic north pole. When the nose of an aircraft is pointing in direction of the earth's magnetic north pole its magnetic heading is zero degrees. When nose is pointing in the easterly direction its magnetic heading is 90 degrees.

“Declination or Magnetic-Declination”

Means the horizontal angle between true north and magnetic north at any place.

“Track”

Is the angle between North-South Velocity and East-West Velocity of a vehicle. When a vehicle is only moving in a northerly direction its track angle is zero. When the vehicle is only moving an easterly direction its track angle is 90-degrees. Since GPS receivers are unable to determine velocity accurately at low or zero speed, due to electrical noise, their track is concomitantly inaccurate at low or zero speed.

“GPS Jammer”

Devices that intentionally jam GPS signals, although illegal in the U.S., have been sold overseas. A 4-watt jammer, the size of a hand held amateur ham radio, was made available for sale during the Moscow Air Show in September 1997. These 4-watt jammers reportedly jam GPS receivers for distances of up to 200-km. Thus, larger jammers the size of a car radio can jam GPS receivers for hundreds of miles. Since jammers are relatively easy to build by terrorists, with standard components available in typical electronic stores, care must be taken to prevent the loss of life when utilizing GPS receivers as the sole means of piloting aboard air carrier vehicles. In many instances the GPS derived position data is unavailable due to geometric problems and severe atmospheric disturbances. Other times, GPS derived position data becomes unavailable from unintentional radio jamming interference emanating from ground electrical equipment. For example, in 1997 GPS position fixing was useless for 300-km in a Continental Airlines aircraft because of an error made by the Air force during one of their antenna tests in Rome, N.Y. Other outages are of unknown sources. The basic problem lies in the fact that the signal strength of the GPS satellite data arriving at the input to a GPS receiver is exceedingly low. This low signal strength allows GPS receivers to be easily jammed.

“Ground Incursion”

It may also be called runway incursion, taxiway incursion, and ramp incursion. The Federal Aviation Administration (FAA) defines a runway incursion as:

Any occurrence at an airport involving an aircraft, vehicle, person or object on the ground that creates a collision hazard or results in a loss of separation with an aircraft taking off, intending to take off, landing, or intending to land.

Reasons given for ground incursion include: unfamiliarity with the local airport layout; disorientation (e.g., unclear taxi instructions, heavy traffic, etc.); separate ground and air traffic controllers; ground control equipment failure, errors of omission and commission by traffic controllers and/or pilots.

“Axis”

Is a directed line segment in space. As used herein, “3-axes” is three separate line segments that share a common origin. Each of the line segments is orthogonal/perpendicular, to (point 90 degrees away from) the other line segments. As such they define a three-dimensional (3-D) vector space. These line segments provide a right-handed 3-D vector inertial reference coordinate frame for the measurement of sensor mounting, rotation rate, rotation, acceleration, velocity, and position.

“Portable”

Characteristic of equipment, which may be either: handheld; or moved from craft-to-craft without undue effort. Typically the installation of portable equipment could be effected without the use of tools or specialized equipment.

To fully appreciate the background of the present invention, a cursory understanding of GPS systems and the limitations of such systems is helpful. GPS systems, of course, are well known in the art. While such satellite systems have delivered low-cost navigation to the masses, there are still a number of inherent limitations, which lead to a need for additional sensors when continuous, reliable, positional information is required.

For example, the integrity and continuity of received GPS signals depend on the number of satellites in the field of view, the satellites' positions in the sky (their “geometry”), and possibly data received from a ground station (e.g., in a differential configuration). When reliance is placed on a satellite system for navigation, on-board equipment must determine the trustworthiness of the GPS information, basically, that the signals being received from satellites are providing a sufficient level of integrity and continuity. This is especially true when a GPS is to be relied on for critical navigation, such as a landing approach for an aircraft. There are simply times and places in the world where the satellites in view cannot support the required continuity and integrity (e.g., for an aircraft approach).

Even when the Satellite geometry supports the required continuity and integrity, the signals received are subject to environmental threats, such as electromagnetic interference (EMI) (both accidental and malicious, GPS jammers), lightning and ionosphere scintillation (e.g., brown-outs associated with sunspot activity). There is also the threat of random satellite failures and satellites setting over the horizon. These situations can affect the reception of some or all of the available satellite signals, resulting in degradation or loss and/or delay of guidance. Some of the threats are not well understood, and will likely remain so for several years. It should also be noted that GPS signals are extremely low power and require a low-noise amplifier to consistently receive an adequate signal. Presently, where economics supports it, e.g., large aircraft, mining vehicles, large boats, or precision farming operations, expensive INS systems are combined with GPS systems in order to overcome the deficiencies of GPS-only systems. In fields where it is not economically feasible to include a conventional INS, i.e., general aviation, recreational boating, conventional farming operations, and the like, there is strong need for an enhanced low-cost positioning system combining a GPS receiver with INS. Evidence of such a need may be found in the number of general aviation pilots who utilize portable GPS receivers with side mounted, in-cabin, antenna. Since many general aviation aircraft are of high-wing designs, these pilots commonly experience higher occurrences of GPS signal blockage and degradation. Almost all such general aviation GPS systems are “single-thread” devices, with no redundant backup safety features.

For the reasons previously noted, GPS is notorious for dropouts. During a dropout, some GPS systems have a continuation or estimation feature, but such systems can only assume that the vehicle is traveling along the exact same track, at the exact same velocity, an assumption which is most likely invalid. Obviously, this situation is wholly unacceptable when precision navigation is required, such as in landing an airplane or piloting a boat in fog and/or at night.

New wireless technologies point to the ever-increasing potential of additional EMI interference. In excerpts from an USA Today article dated Jan. 3, 2002, titled “FCC set to expand wireless frontier” it is stated:

Regulators are poised to approve a breakthrough wireless technology despite concerns by airlines and cell phone carriers about interference. The versatile technology, ultra-wideband (UWB), is expected to revolutionize industries such as consumer electronics. The Federal Communications Commission is expected to OK the technology next month, paving the way for product rollouts this year, say people familiar with the matter. Unlike standard wireless systems, which emit radio waves on specific frequencies, UWB devices send out pulses of radio energy, up to 1 billion a second. It also operates across a wide swath of frequencies, enabling it to run at very high speeds and very low power levels. Thus, unlike narrowband radio waves, UWB signals can penetrate walls more easily. However, users of Global Positioning Systems (GPS) say that by traversing many frequencies, UWB might interfere with GPS systems, such as those used by airplanes to navigate over oceans. Satellite-based GPS signals are very sensitive. “Now is not the time to inject instability into the national air system,” says James Miller of United Airlines. The Department of Defense also has expressed concerns.

INS systems, on the other hand, are not subject to dropouts and can provide a continuous output. Unfortunately, INS positioning systems need to be periodically updated due to degradation in position over time. Because of a craft's dependence on INS, these devices are typically either double or triple redundant, especially on large carrier and cargo aircraft. While an on-board inertial navigation system (INS) is capable of providing position, velocity and attitude that are accurate in the mid term, the errors are cumulative over time, due mainly to imperfections in the inertial sensors and system errors. Current flight-grade INS systems are good to 0.003 degrees/hour. This translates to less than 0.2 navigational minutes per hour or 0.2 nautical miles per hour error in velocity. A 0.2 nautical mile per hour error is equal to 1216 feet per hour or 20 feet per minute. An alternative, and commonly used, method of overcoming gyroscopic drift is to operate an INS in conjunction with another navigation sensor or system, such as GPS, Loran, etc., thus enabling any gyroscopic drift errors in the INS system to be corrected, while concomitantly correcting the position and velocity errors. With an INS system receiving periodic GPS updates, even if there is one-minute of GPS outage during landing, due to any number of reasons, the aircraft can still utilize the INS data supplied to the autopilot/ILS to land safely. Of course these systems are extremely expensive.

Lower cost strap-down INS, on the other hand, are small in size; permit inexpensive navigation and piloting capability but, unfortunately, do not have high performance gyroscopic instruments or high performance accelerometers. One major deficiency, in a low-cost inertial system with poor performance gyroscopes and accelerometers, is that they are unable to accomplish a reasonably accurate gyrocompass function: namely, find an accurate true heading. Thus one can see a trade off exists between high accuracy versus size and cost.

The present stabilized magnetic compasses for boats and aircraft generally utilize a 2-D flux valve, or a magnetic north sensor mounted on a gyro stabilized set of pendulous gimbals. It should also be noted that recreational boats utilizing auto pilots and navigation aids, commonly lose their position reference in heavy-seas, sometimes causing the autopilot to spin the boat upwards of 360 degrees, at the worst possible time with a resulting potential of loss of life and property. As with other gyro-type devices, the stabilized magnetic compass is subject to the same trade off of accuracy versus size and cost.

From an overview standpoint, the current-day, high performance combined INS/GPS systems are bulky and cost prohibitive; particularly to satisfy the requirements sought by general aviation and boating markets. Even when these high-performance INS systems (e.g., approximately $40,000 per system and more) are used, they still must utilize other radio navigation aids to maintain long-term accuracy. Lower cost existing INS/GPS systems do not provide redundant and/or accurate heading data when the vehicle is operating at zero or low-speed. These systems tend to be much bulkier than the present “integrated” invention, and thus lack ease of portability.

The use of navigational information within the airports and airways of the world is rapidly expanding. For example, ADS-B is a relatively new system, which is intended to reduce the incidence of mid-air collisions and ground incursions. While ADS-B systems which report GPS based aircraft position may be within a price range making the system viable for general aviation, such a system would still be limited by the problems associated with GPS. In an Associated Press article dated Sep. 5, 2001, it is stated:

The National Transportation Safety Board, in an unusual move, has asked Congress to prod the Federal Aviation Administration to work harder to prevent planes, vehicles and individuals from entering runways by mistake. The NTSB asked the dozen lawmakers who oversee aviation for their help “in convincing the FAA of the need for immediate action to prevent these potentially catastrophic events.” On average, such incidents happen more than once a day, though the number is down from last year. Between Jan. 1 and Aug. 29, 2001, 268 incursions were reported, compared with 292 during the same period in 2000, when a record 431 incursions were reported for the entire year. More than once a week, on average, a collision is avoided only because a plane or a vehicle quickly moves out of the way. The FAA is installing a new system at major airports that uses existing radar to warn controllers of potential collisions. But NTSB officials say any system should tell pilots that someone is on a runway.

In January 2001, the Inspector General of the US Transportation Department cited the need to reduce runway incursions, which rose to 429 nationally in 2000 against 321 in 1999, according to FAA figures. Runway incursions are incidents that create hazards for potential collisions. In the same report: Peter Challan, a senior FAA air traffic official, said “small private aircraft account for the majority of these incidents”.

Recent US Dept. of Transportation (DOT) statistics show that air travel is over nine times more lethal than bus travel:

US Air Carriers have 4.8 fatalities per 100 million miles traveled based on 5.9 billion vehicle miles.

US Buses have 0.5 fatalities per 100 million miles traveled based on 6.4 billion vehicle miles. Buses were taken for the comparison statistics with carrier aircraft since both are classified as multi-passenger transportation carrier vehicles and their annual vehicle miles are equivalent.

US Motor Vehicles have 1.7 fatalities per 100 million miles traveled based on 2,400 billion miles traveled. Although there are substantially more annual auto fatalities than air carrier fatalities, when compared with miles traveled, it is less lethal to drive to your destination than to fly (Note: Annually in the US there are approximately 407 times more motor vehicle miles than air carrier miles).

Today, even the astronauts, with a 1.90 fatality per 100 million miles traveled aboard the space shuttle in orbit for 0.37 billion miles (14,300+orbits at 25,800 statute miles per orbit), are safer than a passenger traveling in a commercial airliner. This fatality rate includes all seven astronauts that died in the 1986 space shuttle Challenger explosion.

The air carrier fatal accident rate has remained essentially constant over the last twenty years. This constant fatal accident rate is in spite of the advances in:

a) Pilot training due to the use of high fidelity flight simulators.

b) Aircraft materials due to enhanced fabrication methodology and superior metallurgy that has made them stronger and less subject to fatigue.

c) Avionics enhancements due to large scale integrated (LSI) semi-conductors that made the electronics smaller and more reliable, and improvements in engines and fuel that have made them more reliable.

d) Engine reliability due to advancements in engine fabrication and materials, computer aided design (CAD) and simulations.

It should be noted that the above statistics don't include the approximate 3000 aviation-related fatalities that have occurred on Sep. 11, 2001. It should also be noted that even one incursion can put hundreds of lives at risk, such as was the case at Milan's Linate airport in October 2001, where a runway collision between a Scandinavian Airlines SAS 747 jet preparing for take-off, and a small Cessna plane, which resulted in the death of 118 people.

In the years between 1965 and 1970 there was a significant reduction in the fatal accident rate and fatalities. This was due largely to improvements in jet engines that made them more reliable, microwaves that provided enhanced surveillance radar ATC/M and Instrument Landing Systems (ILS), and inertial navigation systems (INS) that reduced the aircraft's dead reckoning position errors. The radar based ATC also significantly enhanced the automated sharing of position/safety data between the plane and the ground monitoring system. Since the 1970', there has not been a significant increase in the number of safety parameters that are automatically shared between the flight deck and the ATC. It has been this stagnation in avionics information that has directly caused the two decades of stagnation in the air carrier fatal accident rate.

Thus it can be seen that there is a need for a low-cost navigator that provides accurate: 3-D Position; Magnetic Heading and heading rate; 3-D Acceleration; 3-D Velocity; 3-D Attitude; 3-D Angular Rate. A system of this type would be particularly beneficial to craft in need of precision navigation (e.g., boats, aircraft, farm tractors, and mining vehicles) and to provide a positioning system with enhanced accuracy, continuity, and reliability. Disposable uses such as smart weapons, could likewise benefit from such a system. The ability to easily and cost-effectively share highly-accurate positional data (including attitude/heading rates, 3D velocity/acceleration/position) with controllers (either ground or air-based), once analyzed, would greatly aid in reducing transportation related deaths.

Thus, it is an object of the present invention to provide a low-cost, combined INS/GPS/MAG navigation system. The inventive approach assesses the trustworthiness of the signal from each sensor to filter out the weaknesses of individual navigational sources, thereby utilizing only the most accurate and reliable characteristics of each source.

It is a further object of the present invention to utilize MEMS technology in a highly accurate 3D redundant navigation system.

### SUMMARY

A low-cost navigational system comprising: an inertial navigation system (INS); and a global positioning system (GPS) receiver. The inertial rate sensors provide continuous motion (e.g., angular rate) data representative of three-dimensional changes in attitude (position derivative signals). In a preferred embodiment, the INS data is output to a microcomputer, which is integrated with data from a low-cost 3-Axis Magnetometer (e.g., a flux gate—for immediate and redundant 3D heading), the GPS receiver, and, optionally, a Barometric Sensor for redundancy and improved altitude data, to provide a total navigation system. The inventive system combines three or more complementary, overlapping navigational data sources, selecting and extrapolating only the best from each of the individual data sources, to overcome the deficiencies inherent in each of the individual navigational data sources. Significant performance enhancements are realized over GPS-alone navigation systems. Such a system can also provide a portable, battery powered, single antenna, single receiver, integrated INS/GPS/MAG solution. The inventive system provides redundant: True Heading; 3-D Position (Latitude, Longitude and Altitude); Magnetic Heading and heading rate; 3-D Acceleration (North-South, East-West, and Vertical); 3-D Velocity (North-South, East-West, and Vertical); 3-D Attitude (Roll, Pitch and Heading); 3-D Angular Rate (Roll-rate, Pitch-rate and Yaw-rate).

In a second embodiment, aimed primarily at general aviation users, the inventive system includes an RF link to broadcast an unique ID along with all, or a portion, of the navigational data via known radio frequencies to controllers or other craft (e.g., direct plane-to-ground, ground-to-plane, plane-to-plane, or with interim satellite relays). Such a system allows better navigation, reduced risk of ground incursion, improved air traffic control, tighter security and, generally, better airspace control. In this embodiment, communications may be local, regional, near-global or global.

With an economically viable navigation system, coupled with an RF link, available to general aviation flyers, low-cost, highly accurate aircraft position data could be utilized to augment the Air Traffic Control (ATC), in-flight and airport taxi collision avoidance systems, as well as to enhance all weather landing systems. Such a system would provide air traffic controllers' ground based radar systems with a level of redundancy and enhance the radar systems by providing high fidelity, three dimensional, worldwide aircraft separation distances, eliminating five deficiencies in the current radar ATC systems:

a. invisibility of small aircraft due to minimal radar cross-section;

b. distinguishing multiple aircraft flying close to each other because of beam width ambiguity;

c. beam shadowing problems;

d. range problems; and

e. earth curvature problems.

Many of today's maritime harbors and channels, which are under radar control, would likewise benefit from such a system.

In still another embodiment, a “watchdog” feature monitors 3D terrain and other aircraft and issues audio and/or visual warning for potential problems such as ground incursion, ground proximity, or collision warnings. The data from the inventive system may be merged with airport/local/regional/global area map databases (on-board or RF from ground station), three dimensional topographical map information (e.g. Digital Terrain Elevation Data—DTED), so as to be visually shown on a moving map display, or other type of display. The system may optionally display a 3D representation of the map data, so as to aid in quick readability and warn a pilot of ground proximity. While similar systems are now well known in the art, they rely on conventional INS methods that make such systems cost prohibitive for all but large commercial aircraft use.

MEMS technology has been perceived as not having the required accuracy for use in traditional INS products. The present invention combines several technologies, in a synergistic fashion, to overcome the shortcomings normally associated with MEMS devices. In general terms, primary systems having exceptional long-term stability, i.e., GPS, MAG, barometric sensors, and the like, are used to provide accurate craft position and attitude. A MEMS based INS is used to “test” the accuracy of each primary system. If the data from the primary system appears accurate, the filter relies heavily on such data. If, because of the anomalies discussed above, the primary system data is questionable, the filter relies most heavily on the MEMS based data. The MEMS initial point (IP) is essentially reset upon each sampling of trustworthy data from the primary systems.

By way of example and not limitation, a 3-axis MAG, in combination with a microprocessor having a magnetic deviation lookup table can provide an accurate 3-D magnetic heading and attitude. Since drift in the Earth's magnetic fields is extremely slow, taking years before any perceivable change occurs, this 3-D MAG system would provide much greater stability (and considerably faster acquisition time) when compared to rate gyros, except for small local magnetic anomalies. In the inventive scheme, MEMS based accelerometers and rate gyros would detect such local anomalies and provide corrected data while the system remains under the influence of the anomaly. The moderate drift of the rate gyros would be insignificant during such a time period. In addition, as the time within an anomaly increases, the system will provide a trustworthiness indication based on the theoretical maximum drift of the inertial system. Thus the combined rate gyros, MAG, and accelerometers system would produce a very accurate attitude and heading. Similarly, the GPS would provide accurate, ongoing position information, likewise tested by the MEMS system. If the GPS data were questionable, the MEMS data would be used in its place. If, instead, the GPS data appears accurate, the new position information is used to reset the IP of the MEMS system. The ability to combine, filter and extrapolate data from the various systems could be accomplished by simply utilizing the well-known Kalman filter approach.

Since magnetic systems require magnetic corrections, such as magnetic declination/deviation and possible vehicle magnetic corrections, the microprocessor of the inventive system can provide the necessary corrections to enhance the accuracy of the magnetic heading and craft attitude. Depending on the specific application, for example, where craft attitude is not important, a single, or double axis MAG could also used in lieu of the 3-axis MAG.

The inventive system uses a low-cost, 3-axis strap-down INS and 3-axis MAG to accomplish the gyro-stabilized magnetic heading at a fraction the size and cost of a traditional gimbaled system. Furthermore, the strap-down system increases the reliability of the 3D heading function and eliminates several of the problems associated with gimbaled mechanisms. More significantly, the inventive system uses MEMS based INS to achieve such functionality at a fraction of the cost of traditional strap-down systems.

The geometric angles for determining position via GPS signals dictate that the vertical axis is less accurate than the horizontal axes. Restated, altitude derived via GPS-only, is inherently inaccurate at any given moment. Consequently this altitude data could not be used in raw form when altitude is critical (e.g., for an instrument landing). The inventive system may also include barometric sensors to add additional accuracy/redundancy in this area. Solid-state Barometric Sensors could be used for determining barometric altitude. These MEMS-like devices are not calibrated in the same manner as a bellows or mechanically based altimeter. By filtering the INS/GPS based altitude with the pressure transducer's data, a very accurate barometric altitude could be calculated. This would rival the best mechanical systems for accuracy, and would not need to be adjusted for local barometric variations, thus preventing the possibility of human error. With the built-in magnetic deviation table, the same prevention of human error holds true for the 3-axis MAG true heading.

Presently ADS-B systems are slowly finding their way into commercial aircraft. Simply because of the applicability of the present invention to the prevention of airport ground incursions and mid-air collisions, and its potential to economically extend proposed systems to provide meaningful information to controllers for all aircraft (as opposed to only large aircraft), some discussion is merited in this regard. Emerging systems have been proposed which report aircraft position to air traffic controllers and nearby aircraft in an effort to reduce the incidence of both ground incursions and mid-air collisions. Reliable heading output is critical, as opposed to track, for the prevention of airport ground incursions. Unfortunately, ADS-B systems are available which rely solely on GPS data in an effort to offer a system that is economically viable for all classes of aircraft. As previously mentioned, when the vehicle velocity is very low, the GPS-only velocity output is very noisy, resulting in an erratic track angle, which varies widely and becomes unreliable. When the vehicle is stationary, or turning at low speeds on the ground, the track data can be non-existent. Therefore, in an air traffic control system, it is dangerous when a controller has a first airplane sitting, or moving slowly, on a cross-taxiway near an active runway, and a second plane about to be cleared for takeoff. A controller cannot be sure which direction a plane will move if the first plane has a GPS-only ADS-B system. As will be appreciated by those skilled in the art, even when cleared to move and after the application of power, it may take several seconds for the aircraft to move sufficiently to develop an accurate track angle. When the success of ground incursion avoidance can turn on fractions of a second, this is wholly unacceptable. The inventive system, on the other hand, continuously provides true vehicle heading data, track data, velocity, acceleration, and position to the ground stations, as well as other aircraft, and thus supplies the needed information for the safe control of the runway. The same holds true for ground-based airport support vehicles. Also, with the introduction of an improved expert system, with automatic incursion warnings via RF means, accurate (and nearly instantaneously) heading data would be of great aid in the prevention of loss of life and property. The warnings themselves could be both visual and auditory. Most avoidance warnings could be “pre-canned” (audio, visual) within the inventive system, allowing a simple code (e.g., sent by ATC) to be transmitted (e.g., code 1 for ground incursion warning, code 2 for mid-air collision warning, etc.), thus saving valuable bandwidth and increasing response time. In the auditory mode, the warning could be in the pilot's native language, to increase response time (or combination of English and native language). Digital data encryption and error correcting RF schemes are well known in the art, and may also be integrated into the present invention.

In yet another embodiment, an interface could be added to the inventive system, allowing it to also pickup brake and thrust/throttle data from, for example, aircraft and airport land-based vehicles. This additional data would also be included in the RF transmission. The combination of continuous heading, position, acceleration, unique ID, throttle/trust and brake data, once analyzed at the ATC ground station or aboard other aircraft, would represent a substantial improvement in runway incursion systems. These systems could show a representation of aircraft that has its brakes on, and having zero thrust, in a first color, for example, red. As will be appreciated by those skilled in the art, there is a delay between the time thrust is applied, and the time the aircraft actually begins to move. This can be a fatal system flaw, since this delay in notification, allows incursion warning systems that do not also monitor thrust/brake data to show “all systems go” for take-off of the second aircraft, when in-fact, the first aircraft has it's brakes off and has just applied thrust and is about to enter the active runway. This is further complicated by the fact that the controller may be unaware of which way the intruding aircraft is actually pointed. There is also the risk of additional GPS dropouts due to the line-of-sight interference of GPS signals when an aircraft is on the ground.

In still another embodiment, the inventive system may include a CAN-BUS interface, or the like, for use on farm equipment, mining equipment, or military vehicles.

### DESCRIPTION OF THE DRAWINGS

The present invention is illustrated by way of example and not by way of limitation in the figures of the accompanying drawings in which references indicate similar elements and in which:

FIG. 1 is a block schematic of an aircraft's multiplexed flight sensors, sensor transmitter and advisory receiver according to the invention.

FIG. 2 illustrates the worldwide communication via a satellite system according to the invention.

FIG. 3 illustrates the Ground Based Distribution and Data Transmission System according to the invention.

FIG. 4 is an example of Ground Incursion risk.

### DETAILED DESCRIPTION

Before describing in detail the redundant navigation system in accordance with the present invention, it should be observed that the present invention resides primarily in what is effectively a novel combination of conventional and emerging navigational circuits and components, and not in the particular detailed configurations thereof Accordingly, the structure, control and arrangement of these circuits and components have been illustrated in the drawings by readily understandable block diagrams which show only those specific details that are pertinent to the present invention, so as not to obscure the disclosure with structural details which will be readily apparent to those skilled in the art having the benefit of the description herein. Thus, the block diagram illustrations of the Figures do not necessarily represent the mechanical structural arrangement of the exemplary system, but are primarily intended to illustrate the major structural components of the system in a convenient functional grouping, whereby the present invention may be more readily understood.

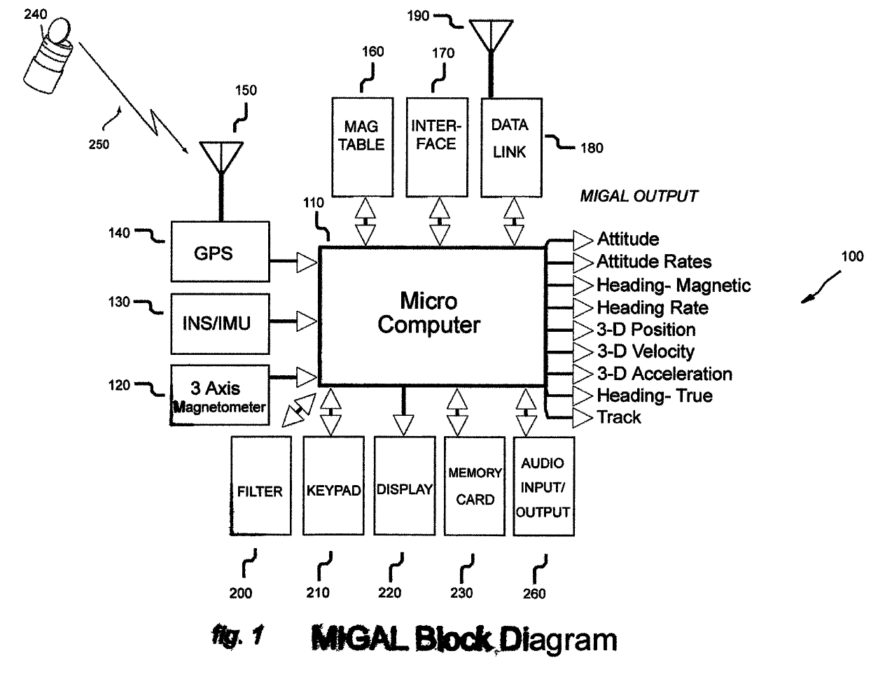

Turning first to FIG. 1, the inventive navigational system 100 preferably comprises: a GPS receiver 140; an INS 130; a magnetometer 120; a computing device 110; an user interface including a keypad 210 and a display 220; nonvolatile memory 230; and a magnetic lookup table 160. In addition, the inventive system may include interface 170 for communicating with other systems or a computer and, when used as part of an anti-incursion, anti-theft, or anti-collision, the inventive system will typically include a radio frequency data link 180 and antenna 190.

As will be appreciated by those familiar with GPS systems, GPS receiver 140 receives signals, as indicated by arrow 250, from a plurality of satellites (only an exemplar satellite 240 shown) through antenna 150. From the timing of the information received from various satellites, the GPS receiver 140 calculates a reasonably precise position. As will also be apparent to those skilled in the art, GPS systems are capable of higher accuracy when coupled with a fixed receiver and used in a differential mode.

Turning next to the inertial navigation system 130 (INS or IMU), INS 130 preferably includes a 3-axis gyro and 3-axis accelerometer. Most preferably, the gyro devices are of the MEMS type. While the long-term stability of MEMS gyros is typically not as good as other types of gyros, the cost, durability, and size of MEMS devices makes their use attractive. In general, inertial systems are well known in the art, whether MEMS, or otherwise, and the integration of an INS system into the present invention is well known within the skill level of one ordinarily skilled in the art.

Magnetometer 120 is preferably of the flux gate-type and typically comprises a 3-axis device. As is well known in the art, the lines of magnetism which surround the earth have a generally known, three dimensional orientation at any point on, or above the earth's surface. Traditionally, 1, 2, or 3-axis accelerometers have been used to determine a horizontal heading in flux gate compasses. However, if the angle of the field line is known at a given point in space, a 3-axis magnetometer may be used to determine the attitude of a craft, not just the heading. The magnetic properties of the earth have been well documented.

The magnetic field of the earth has several properties that make it an ideal navigational tool. For example, changes in the magnetic field occur at a very slow rate typically taking years to exhibit any appreciable change, the direction of the field lines at any point can typically be predicted mathematically, and anomalies in the earth's magnetic field tend to be relatively minute and be present over relatively small areas. It should be noted that, with the presence of the GPS system, the position of the craft in three-dimensional space is always known within a reasonable degree of accuracy. To determine the precise angle of the earth's field at any point, the angle may be looked-up from table 160. When the location is between table entries, the angle may be interpolated from the nearest entries surrounding the present point. In addition, table 160 may also hold known anomalies in the earth's field, thereby allowing correction of craft attitude when operating in such areas.

Computing device 110 is typically a microprocessor, risk-type processor, digital signal processor, or the like. Most preferably, computing device 110 is a digital signal processor so that signal conditioning of the outputs from the various sensors, 140, 130, and 120 can be implemented in software. In addition to interfacing the various sensors 140, 130, 120, computing device 110 also receives input from filter 200, keypad 210 which may be used to select from various operational modes, enter or select waypoints and routes, select map scale, security code, flight and/or tail number, etc., and computing device 110 provides output to a user through display 220 and audio input/output 260. In a typical operational mode, computing device 110 receives period positional information from GPS receiver 140. Upon receiving such information, computing device 110 reads positional information from the INS 130. This information along with other (e.g., MAG 120, MAG table 160, etc.) is processed through filter 200 (e.g., Kalman). If the GPS positional information agrees with the INS position, within the tolerance imposed by the accuracy of the GPS 140 and drift rate of the INS 130, the GPS position is accepted as accurate and the initial point for the INS 130 is set to the present position. If, on the other hand, data from the GPS is not believable (or non-existent due to a temporary dropout) relative to data from the INS 130, the position supplied by the INS 130 is considered trustworthy and used in lieu of the GPS position. If INS data is chosen, a trustworthiness variable is incremented so that the computing device 110 can track the theoretical maximum deviation from any displayed position. Upon reading a valid GPS position, within the range specified by the trustworthiness value, the valid GPS position is again used as the IP and the trustworthiness value is reset. In addition, it should be noted that, if positional information is needed at a higher rate than provided from GPS receiver 140, INS data could be used to interpolate until the next GPS update rather than relying on static operation of the craft.

Once an accurate position is determined, computing device 110 typically obtains a vector angle of the magnetic field at the present position from magnetometer 120. It should be noted that, as used herein, position refers to the position of the craft in three dimensions. By simply comparing the magnetic field vector input from magnetometer 120 with the angle found in table 160, the attitude, pitch, roll, and heading, of the craft may be easily determined. As with position of the craft, the attitude determined from magnetometer 120 is compared with the attitude read from INS 130. If the magnetometer attitude matches the INS attitude, in light of the theoretical accuracy of the magnetometer 120 and the drift rate if the INS 130, the magnetometer attitude is considered accurate and considered the present attitude of the craft. In addition, the present attitude becomes the initial attitude of the craft for subsequent INS calculations. If, on the other hand, the value read from the magnetometer 120 does not match the INS value, it is assumed that an anomaly exists and the INS attitude is used. Likewise, a tally is kept since such that an accuracy value may be calculated based on the drift rate of the INS 130 until a valid magnetometer value is read.

In addition, computing device 110 may one or more databases to improve the presentation of navigation information on display 220. By way of example and not limitation, a 2-dimensional map database could be used to show the craft on a map. By selecting the overall area to display, a user can see his or her position relative to landmarks, i.e., cites, bodies of water, roads, etc., or plan a route to follow. Alternatively, topographical data could be used to simulate a 3-dimensional display to show the position of the craft relative to features of the terrain. Such a feature could help pilots detect ground proximity far earlier than other on-board systems could. Similarly, when the inventive system is adapted for use on a boat, a database could be used to display waterway features, or hazards, relative to the boat's position, such as channels, boating hazards and obstructions, mooring details, bottom contours, buoy information, locks, etc.

Memory card 230 is preferably a nonvolatile memory such as compact flash memory. Such devices are well known in the art. Memory 230 is used to store waypoints, routes, breadcrumb information, and other navigational values. In addition, memory 230 may be used to store calibration information for the system 100 or database information as discussed herein above.

As will be apparent to those skilled in the art, MEMS gyros, accelerometers, and magnetometers are typically analog type devices and typically have tolerances as to scale factor and zero offset. Historically, systems provide adjustments to allow the system to adapt individual sensors. However, in the inventive system, since position, velocity, track angle, altitude, accelerations, and the like, can be derived from GPS data while the craft is in motion, it is possible to program the inventive system 100 to self-calibrate over its first few minutes of operation. The scale factors and zero offsets required for each sensor are then stored in nonvolatile memory 230 for subsequent operation of the system 100.

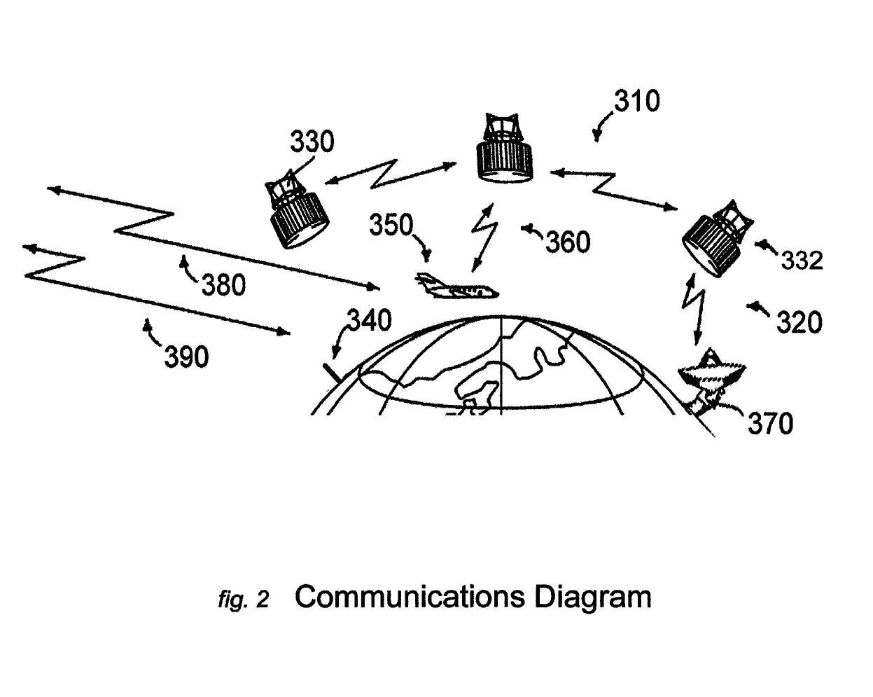

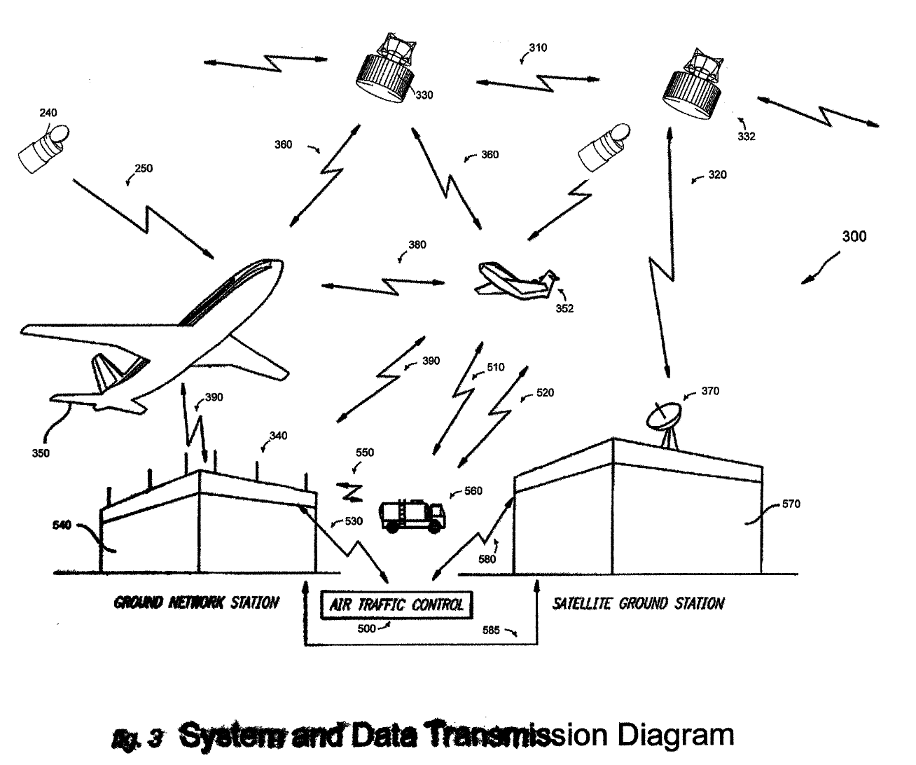

In another preferred embodiment, data link 180 is included in the inventive system for communication with other navigational systems and/or ground based systems as part of an anti-incursion or anti-collision system 300 (FIG. 3). As part of such a system 300, the navigational system 100 periodically, or upon the request of another unit, reports its associated aircraft's position, attitude, velocities, rates, and acceleration. Referring to FIG. 2 and FIG. 3, wherein is shown an example of an anti-collision or anti-incursion system, typically, aircraft 350 and 352 are equipped with the inventive system including data link 180 (FIG. 1). On each aircraft 350 or 352, the navigational system 100 receives GPS information 250 from, for example, satellite 240. Each system 100 sends the craft identification, position, attitude, velocity, rate, and/or acceleration information for use by other craft. In addition ground vehicle, such as truck 560 may be equipped with the inventive system to reduce the risk of incursion with taxing aircraft. As can be seen in FIG. 3, at one level aircraft 350 and 352, vehicle 560, as well as structures 540 and 570, communicate directly as indicated by arrows 390 (via antenna 340), 510, 550, and 380. Each craft 350, 352, 585 and 560 receives the position of each nearby craft, and compares the received positions to its own position. If, in light of the position, heading, and velocity, of the crafts, there is a risk of collision, the on-board system notifies the pilot or driver.

At a second level, the navigational system 100 communicates over a global communication network. In a networked system, each craft communicates via satellite to a central ground based station 570. As indicated by arrow 360 (FIGS. 2 and 3), aircraft 350 communicates with satellite 330, as also indicated by arrow 360 aircraft 352 communicates with satellite 330, and, as indicated by arrow 520, truck 560 communicates with satellite 332. Signals are relayed between the entire network of satellites, of which satellites 330 and 332 are representative, as indicated by arrow 310, and ultimately to the central station 570 as indicated by arrow 320. Computers at central station 570 can evaluate the positions, headings, and velocities of aircraft over a large area, perhaps even worldwide, to ward off collisions even in areas far removed from airports or air traffic control radar. When the potential for a collision or incursion is detected, ground station 570 issues a warning to the appropriate craft through antenna 370 and the satellite network.

In the direct, craft-to-craft communication scheme, or the networked scheme, accurate position information may be forwarded to the air traffic controllers 500, as indicated by arrows 530 and 580, to augment convention radar systems. By receiving more accurate information and timely heading and velocity information, the controllers can make better, more informed decisions concerning the movement of air traffic through the airspace or along taxiways.

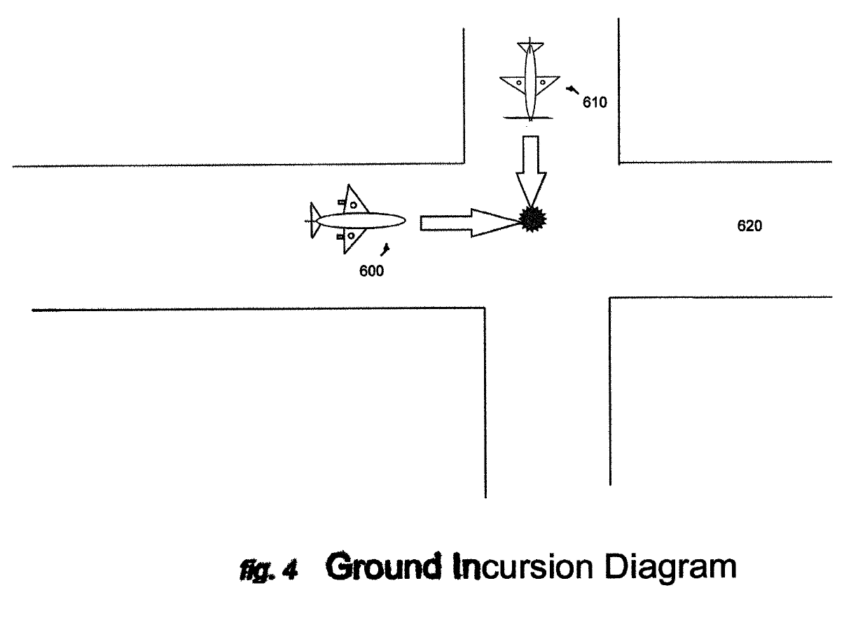

Turning now to FIG. 4, the potential for a serious incursion exists whenever an aircraft holds on a taxiway for an aircraft to land or takeoff. Generally speaking aircraft 610 will be directed to stop short of runway 620 if aircraft 600 is landing or taking off. Different pilots will exhibit widely varying behavior under these circumstances. Some pilots may reduce power to ground idle and release the brake after the aircraft 610 is stopped. Other pilots may leave the power with enough thrust to move the plane but stand on the brakes, particularly if the pilot believes the delay will be short. Problems arise over a number of circumstances, for example: with the brake off, the plane may creep forward without the crew noticing; with power up, the pilot may inadvertently allow the plane to creep into the runway; or, with power at ground idle, the delay between the application of power and actual movement may be longer than that anticipated by the ground controller and result in interference with the next plane landing or taking off.

If the present system were in place, and with further reference to FIG. 4, a computer, either on-board both aircraft 600 and 610 or at central station 570 would receive position, and heading, and velocity and acceleration vectors from aircraft 600 and 610. From this information, at the first movement of aircraft 610 the computer would sense the potential for collision and immediately warn the pilots of both aircraft 600 and 610. Obviously, if aircraft 610 were creeping forward, such a warning could avert a collision. If aircraft 610 were slow to proceed after being directed to cross-runway 620, the inventive system would immediately provide the low acceleration information to the ground controller providing ample time to reassess the situation.

As will be apparent to those skilled in the art, numerous additions to the inventive system, which would improve its suitability to a particular environment. For example, when the system has been turned off, the last attitude and heading of the MAG is stored in the computer memory. Upon resumption of power, the system assumes the vehicle is still in the same position and quickly displays a usable vehicle attitude and heading. This fast display also occurs even when the aircraft is moved around the airport, since it is extremely doubtful that the aircraft could have moved sufficiently to affect the accuracy of the MAG the update rate from the MAG is essentially unlimited. Typically, the GPS too will provide a relatively fast initial position since the latitude and longitude will not have changed enough to upset the GPS search of its constellation. To further increase safety and speed up reporting time, the inventive system could be designed with an intelligent power management and safety scheme. Specifically, the accelerometers themselves could be in an “always on” state, continually tracking any movement, since MEMS based “INS” accelerometers have minimal power requirements (e.g., 40-50 mAh), and the system may contain a built-in battery power source (either as primary, or backup). Whenever movement is sensed, the full system could immediately return to an active state, so as to track all position and attitude changes, regardless of whether the vehicle itself is running or not. Momentary GPS updates may be also included to further verify position data. This could also allow heading/attitude/position data/acceleration/ID etc., to be automatically sent via RF, in virtually real time, whenever movement was sensed, to ATC ground stations, as well as other aircraft, for analysis. Prior art systems must wait for GPS signal acquisition and/or risk reporting possibly inaccurate data, upon resumption of power. Vehicles with conventional gyros must first wait for spin-up/calibration time. MEMS device dot not suffer from this limitation. This unique “no delay” reporting feature would further assist in the prevention of ground incursion. This applies to both aircraft, and more peculiarly to airport support vehicles. With respect to sensing vehicle movement, the always-on accelerometers would have a much faster response time over GPS, in sensing and reporting vehicle movement, thereby providing a greater degree of safety. This is peculiarly important with vehicles that do not report brake/throttle sensor data to ATC and other aircraft. High-rate duty cycle power management schemes could also be utilized to reduce the, otherwise always on, INS accelerometers power requirements, e.g., down to the range of approximately 2-4 mAh. The same management system, could allow “parked” craft to report their position/attitude less often and/or on secondary RF channels, to help minimize system overload.

With most aircraft manufacturers using an “common” key (one key fits every airplane of a specific model or models—e.g., Cessna, Lear), and local flight centers and locksmiths selling these generic keys, thus one can see that security can be easily breached. In excerpts from a Los Angeles Times article titled: “Crash Reveals Small Planes as Giant Security Headache” (Jan. 8, 2002), it states:

Pilots such as the teen who hit a Tampa high-rise would be hard to stop, experts say. Small planes, common in U.S. skies, are a potential security nightmare, experts say . . . . The case of an apparently suicidal teenager who crashed a plane into a Tampa, Fla., high-rise presents federal officials with a dilemma: how to bolster the security of private aviation without suffocating its long tradition of free flight. A post-September 11 security system is already in the works for airlines. But providing protections for more than 200,000 planes, 18,000 airports and 500,000 pilots in private aviation is a tricky balancing act. “How do you have some security without crushing that free spirit?” asked Gerald Dillingham, director of aviation issues for the General Accounting Office. “Right now there is very little checking of private pilots or their passengers. Maybe the beginning of an answer is that we need to recognize we have a security gap.” Small planes do not pack the sheer destructive power of jetliners. But little planes often putter about the skies with much less scrutiny than large jets. Although commercial aircraft fly assigned routes specified and monitored by air traffic controllers, pilots of small planes often rely instead on their eyes and instruments to navigate. The Tampa crash in which a 15-year-old flew a plane into a 42-story building—raises questions about whether such an incident could happen again with deadlier repercussions. To dismiss Charles Bishop, who left a note expressing sympathy with Osama bin Laden, would be risky, private security experts said. If a troubled teen could get hold of a small plane, so can a terrorist. “We can't just brush this thing off as some kid who went down,” said Charles Slepian, a New York lawyer who runs a think tank on transportation safety. “That's what it may be, but it should serve as a wake-up call. If you pack that Cessna with C-4 explosives and a detonator, it is a delivery system.” Billie H. Vincent, a former Federal Aviation Administration security chief, said the government should conduct a thorough risk analysis of potential threats posed by private planes. He believes that jets and flight schools are the segments of the private aviation community where additional security measures would bring the greatest benefit. “When you look at what you can do about this, corporate jets and flying schools are the things you need to look at,” Vincent said. In a report to Congress last month, the Transportation Department acknowledged that light planes “could be used to strike ground-based targets.” “Their load-carrying ability, even if limited, enables the delivery of explosives, compensating for their relative lack of kinetic energy [speed] or fuel,” the report says. “Given the ubiquity of general aviation aircraft and airports, such aircraft are never far from major urban centers, critical infrastructure and other targets.” Bishop's fatal flight illustrates how vulnerable critical targets can be. Authorities said they were relieved the teenager didn't aim for the military's nearby U.S. Central Command, which directs the troops in Afghanistan. In 1994, a small plane hit a tall tree outside the White House residential quarters. The pilot was killed, and his intentions remain unclear.

As a security measure, craft (e.g., aircraft, ground support) could be required to enter a security “code” (e.g., received from ATC controllers) into the keypad 210 of the inventive system 100, before moving the craft. This code, along with unique ID and other data, would be sent via RF to a remote station for monitoring, analysis and archiving. Unauthorized craft movement could then be easily detected (e.g., human oversight, and/or expert systems, to name a few), and serve as an early warning indicator of a security breach. The inventive system or an independent external device (with its own keypad) could be designed to disable the craft's ignition system (e.g., via relay and interface 170), if the proper security code was not entered (e.g., manually entered by pilot, or sent by ATC controllers via data RF transmission through datalink 180, ADS-B system or transponder), thus preventing the craft from taking off (the aircraft's weight on wheels sensor may also be used for increased safety and security). As additional security measures, small self-contained portable systems (with or without gyroscopic devices) could be designed as a roof, trunk or hood mounted system (e.g., suction cups), for temporary airport vehicles. Similar low-cost units (with or without keypads) could also be attached to mobile objects, such as barricades. Tamper-sensing circuitry may also be included within any of these security-enhanced systems, to activate audio and/or visual alarms, as well as RF advisories to help thwart would-be intruders. Regarding security and continuity of RF transmissions, GPS jammers are now of common-knowledge, and can easily overpower the low-level GPS signals, thereby rendering any GPS-only ground incursion system, or even in-flight systems for that matter, useless. The inventive primary INS navigation 130 will continue to fill the gaps between successfully received GPS updates even when the jamming lasts an inordinate length of time. Jamming of the optional RF data link 180 would be much more difficult and in fact, schemes exist to protect RF datalinks from just such jamming. Thus, this improved system has a much higher probability of continuity.

The inventive system 100 may also contain a diagnostic monitoring system (e.g., low-voltage, system component failure, etc.) with the resulting advisories being auditory, and/or visual, and may also sent via RF to ATC ground stations and airport maintenance personnel.

It should be noted that the MAG 120 sensors may be mounted remote from the navigational system in a location on the craft that minimizes vehicle induced magnetic fields, or magnetic shielding effects that attenuate the earth's magnetic field sensed by the MAG in an iron or partially iron vehicle (e.g., mining vehicle, iron ship, automobiles, etc.). By way of example and not limitation, such locations could include the outside skin of a vehicle or on a mast.

As previously mentioned, the inventive navigational system 100 can optionally be equipped with a digital interface 170 as shown in FIG. 1. If interface 170 is of an industry standard type data bus, such as an ARINC type bus, advantages may be realized on two fronts. First, the inventive system 100 can receive, record, analyze, and display data from other systems, such as control position information, control surface position information, fuel flow, fuel quantity, braking status during taxiing, and the like. As will be apparent to those skilled in the art, this type of data has traditionally been stored in flight data recorders on large aircraft so that, in the event of a crash, the data may help determine the cause and help to prevent future crashes. Since system 100 includes a nonvolatile memory, such as a compact flash device, information presented on the bus along with the navigational information developed by the system 100 to effectively perform the functions of a flight data recorder. Due to the low cost of the inventive device, this is of particular interest in the general aviation arena where flight data recorders have been conspicuously missing. In addition, an optional microphone may be included and run through audio input/output 260 for an enhanced feature. Other optional sensors could be added to increase the effectiveness of system 100 in such an embodiment. Such sensors could include an oxygen monitor, carbon monoxide detector, smoke detector, fuel flow sensor, aircraft voltage sensor, and/or cabin pressurization transducer. Since general aviation aircraft tend to fly slower, weigh less, and support flatter glide paths, crashes are typically less violent than are those of larger planes. Thus, the inventive system would not require the degree ruggedization employed in a traditional flight data recorder to provide a high degree of functionality in general aviation aircraft. In fact, in such a use, since compact flash devices possess an industry standard interface and are thus readable in other systems, only the survivability of the compact flash device 230 would be at issue. To improve the survivability of the memory device 230, impact absorbing material, a thermal insulator, and corrosion resistant coatings could be used to protect device 230. In addition, the computing device 110 could analyze data from it's own system, along with other systems, particularly in light of the position and attitude of the aircraft, to alert the flight crew of potential problems, and failures. This data would be of great aid in post crash analysis (e.g., NTSB), and would also provide much needed data to aircraft manufacturers, which once analyzed, could aid in detection of design flaws.

When system 100 is further equipped with data link 180, the on-board microcomputer 110 could be programmed to sense the violation of normal flight parameters, such as inverted or near inverted flight, spin, steep descent, etc., and issue, whether automatically or pilot initiated, an SOS including an aircraft ID, current location, and flight parameters via data link 180. Obviously, such information would greatly simplify the search and rescue operations for a downed craft.

As will also be apparent to those skilled in the art, the inclusion of interface 170 would allow the inventive device 100 to send data to other avionic systems. For example, in light of the low-cost of the inventive system, an interface open to other systems could well provide the impetus for the development of other low-cost aircraft systems such as an autopilot for full 3D auto-navigation, thus allowing the features of a much more costly system. Such a low-cost autopilot could provide emergency feature heretofore unavailable on general aviation such as a go-around feature for use when unforeseen emergencies arise during landing or an emergency recovery system, which would return the aircraft to a straight and level attitude, in the event that the aircraft is in violation of normal flight parameters (such as inverted or near inverted flight, spin, steep descent, etc.). This recovery could be implemented either automatically, or be pilot initiation. The same RF equipped system could also be utilized for real-time remote monitoring of a craft for additional safety and security. The craft's 3D positional data along with any of other the optional senor data (black box data) could be included in the RF transmission. Restated, such a system could be utilized as an integrated navigation/flight data recorder transmission system, allowing remote wireless retrieval of black box data for remote analyzing and archiving. This real monitoring of black box data could provide a remote “second set of eyes” to detect potential problems (possibly even before the flight crew has recognized such a problem).

Perhaps one of the most significant advantages of the present invention can best be recognized by looking at the aviation industry as a whole. There currently exists a black hole within general aviation. A general aviation pilot wishing to upgrade the “primary” navigation system on a plane has two choices: One, install a FAA certified system. Unfortunately, the manufacturers of “certified” systems currently face multi-year approval timeframes and costs, which can approach a million dollars, to receive the FAA endorsement. This greatly delays getting technology into the hands of those who need it the most, or completely precludes systems that would otherwise be viable. The second option is to install an un-certified primary system, and obtain a FAA waiver. This process shifts the oppressive approval burden on the owner. While such approval process is obviously less expensive, it is, nonetheless, out of reach for most pilots. Since the inventive device is portable and self-contained, the system can be utilized as a “backup” navigation device, without the need of FAA approval. This allows the pilot of a small craft to have navigational features and safety features that rival those of an airliner. It should be noted that this increases the safety of flying not just for the pilot of that aircraft, but also for the passengers of airliners that share airspace and taxiways with the pilot. Attention should be paid to the “real-world” and the fact that the price to outfit general aviation aircraft and land-based airport vehicles, will directly effect the overall acceptance, future implementation, and success of improved air traffic control systems, such as the new ADS-B system and the FAA's Capstone project. The same holds true for an improved ground incursion avoidance system. The inventive system, with the built-in RF Datalink option, could be easily moved from plane to plane, an advantage of particular interest to pilots who rent aircraft, allowing the craft to report its position, attitude, velocity, acceleration, unique ID, etc. and receive digital RF ATC instructions, weather data and advisories. This provides a much needed increase in the margin of safety in flying in today's crowded airspace. An optional external monitor and/or keypad could be included to enhance the system (e.g., yoke mounted).

Those skilled in the art could design a system with double or triple redundancy, utilizing the inventive system's low-cost components. By way of example and not limitation, a higher functional availability/reliability could be obtained by mounting multiple (e.g., triple) INS so that none of the gyroscopes sense identical vehicle or earth rate. In this triple redundant INS configuration, each of three INS systems would each consist of three gyroscopes (e.g., X, Y, and Z) per system, such that each system acting on its own, could provide an inertial navigation solution. Each of the three INS, on the vehicle, could also be mounted tilted or skewed, with respect to the other INS. Thus, no two gyroscopes have identical spatial sensor axis, with respect to earth and vehicle. When this is done, even if the same gyroscope, for example the X gyroscope, fails to function properly on each INS, its rate sensor function, with respect to the vehicle and earth, can be derived by the computing device which makes trigonometric combinations of the data from the other functioning gyroscopes. In this tilted or skewed redundant system configuration, the overall system functional availability/reliability increases. Thus, a three INS tilted configuration, which shares the gyroscopic data with the computing device, has an overall system functional availability/reliability that is greater than three completely independent redundant systems. The same argument holds for the INS accelerometers. Redundant GPS receivers could be utilized in many capacities. For example, the redundant receiver(s) could be utilized only as a back-up system. A second example, wherein each receiver has its own antenna (and preferably power circuit), could allow GPS attitude, thereby providing another redundant attitude reading (a single GPS receiver with multiple antenna scheme could also be utilized). These multi GPS/antenna configurations would best be used in a fixed (non-portable) installation. Any number of sub-set combinations of the system components could be designed to make a mid-level redundant system. Any and all of these additional redundant options would give the general aviation community additional safety features never before possible, and further aid in the prevention of loss of life and property.

While the present invention has been described with reference to specific exemplary embodiments, it will be apparent to those skilled in the art that various modifications and changes may be made to these embodiments without departing from the broader spirit and scope of the invention as set forth in the claims. Since modifications of the disclosed embodiments incorporating the spirit and substance of the invention may occur to persons skilled in the art, the invention should be construed to include everything within the scope of the appended claims and equivalents thereof. Accordingly, the specification and drawings are to be regarded in an illustrative rather than restrictive sense.

What is claimed is:

1. A navigation system, comprising:
(a) a GPS receiver adapted to receive electromagnetic signals from a plurality of satellites, said GPS having a first output for providing a signal indicative of the position of said GPS receiver;
(b) a magnetometer positionable for measuring one or more components of the earth's magnetic field, said magnetometer having a second output for providing a signal indicative thereof;
(c) an accelerometer for measuring one or more axes of acceleration, said accelerometer having a third output for providing a signal indicative thereof; a
(d) a 3-axes rate gyroscopes for measuring the rate of rotation of the navigational system, said rate gyroscope having a fourth output for providing a signal indicative thereof; and
(e) a computing device having:
(i) a plurality of inputs, at least one input of said plurality of inputs in communication with each of said first, second, third, and fourth outputs; and
(ii) a database of the magnetic fields of the earth.

2. The navigation system of claim 1 further comprising one or more barometric sensors, for measuring atmospheric pressure and providing signals indicative thereof.

3. The navigation system of claim 1 wherein said 3-axes rate gyroscope is a MEMS based rate gyroscope.

4. The navigation system of claim 1 further comprising a display means for visually displaying information from said computing device.

5. The navigation system of claim 1 further comprising an aural transducer for communicating audible information from said computing device.

6. The navigation system of claim 1 further comprising a battery wherein the operating power for the navigation system is supplied by said battery.

7. The navigation system of claim 1 further comprising an RF data link configured for digital communication.

8. The navigation system of claim 1 further comprising nonvolatile memory for storing flight navigational information.

9. The navigation system of claim 1 further comprising an interface for communicating with avionic systems of an aircraft.

10. The navigation system of claim 1 further comprising a sensor for determining the braking status of a vehicle when the system is installed in said vehicle.

11. The navigation system of claim 1 further comprising a sensor for determining the position of a throttle in a vehicle when the system is installed in said vehicle.

12. The navigation system of claim 1 wherein the navigation system is configured for portable operation.

13. The navigation system of claim 4 wherein said display shows at least one of the navigational components selected from the group consisting of:
(a) position;
(b) heading;
(c) velocity;
(d) acceleration;
(e) pitch;
(f) roll; and
(g) track angle.

14. The navigation system of claim 1 wherein said computing device includes a Kalman filter and wherein said first, second, third, and fourth outputs provide inputs to said Kalman filter.

15. A method for managing the electrical power in the navigation system of claim 1 when the navigation system is in a power-conserving mode including the steps of:
(a) applying power to said accelerometer;
(b) reading the acceleration of the system from said accelerometer;
(c) determining if the system is in motion;
(d) if the system is in motion,
(i) terminating the power conserving mode; and
(i)(i) applying power to the remaining circuitry of the navigation system; and
(e) if the system is not in motion,
(i) removing power from said accelerometers;
(ii) delaying a period of time; and
(iii) repeating steps (a)-(e).

16. The navigation system of claim 1 wherein said computing device includes database information selected from the group consisting of:
(a) 2-D map information;
(b) topographical information; and
(c) oceanographic information,

17. The navigation system of claim 1 further comprising a memory card.

18. The navigation system of claim 17 further including at least one protectant for said memory card selected from the group consisting of:
(a) inertia absorbing material;
(b) heat insulating material; and
(c) corrosion resistant conformal coating.

19. A navigation system, comprising:
a Global Positioning Sensor receiver adapted to receive electromagnetic signals from a plurality of satellites to determine a position, said Global Positioning Sensor receiver having a first output for providing a signal indicative said position;
an accelerometer for measuring one or more independent components of acceleration, said accelerometer having a second output for providing a signal indicative of said one or more independent components of acceleration;
a rate gyroscope for measuring three independent components of rate of rotation, said rate gyroscope having a third output for providing a signal indicative of said three independent components of rate of rotation;
a computing device having a plurality of inputs for in communication with said first, second, and third outputs; and
a housing wherein is housed said Global Positioning Sensor receiver, said accelerometer, and said rate gyroscope, wherein said housing is configured such that the navigation system is portable.

20. The navigation system of claim 19 wherein said rate gyroscopes are MEMS based.

21. The navigation system of claim 19 further comprising a barometric sensor for measuring the altitude of the navigation system.

22. The navigation system of claim 19 further comprising a display for visually displaying navigation information to an operator.

23. The navigation system of claim 19 further comprising an audio transducer for providing information aurally to an operator.

24. The navigation system of claim 19 further comprising a battery housed in said housing for providing electrical power for the operation of the navigation system.

25. The navigation system of claim 19 further comprising a data link for communicating with other navigation systems.

26. The navigation system of claim 19 further comprising a memory card readable and writable by said computing device.

27. The navigation system of claim 19 portable for use on a craft, further including a braking system sensor for measuring a braking force of the craft.

28. The navigation system of claim 19 portable for use on a craft, further including a throttle position sensor for measuring a throttle position of the craft.

29. The navigation system of claim 19 portable for use on a craft, further including a tamper determining means to detect tampering with the craft.

30. The navigation system of claim 29 further comprising a keypad for inputting navigational information to said computing device and for inputting a code to distinguish legitimate use of the craft from tampering.

31. The navigation system of claim 22 wherein said display can be configured to display at least one navigational parameter selected from the group consisting of:
(a) the track of a vehicle;
(b) the heading of the vehicle;
(c) the velocity of the vehicle;
(d) the acceleration of the vehicle;
(e) the pitch and roll of the vehicle; and
(f) the braking status of the vehicle.

32. The navigation system of claim 19 wherein said computing device processes the signals from said first, second, and third outputs through a Kalman filter.

33. A method for managing the electrical power in the navigational system of claim 19 including the steps of:
(a) applying power to said accelerometer;
(b) reading the acceleration of the system from said accelerometer;
(c) determining if the system is in motion;
(d) if the system is in motion,
(i) terminating the power conserving mode; and
(i)(i) applying power to the remaining circuitry of the navigation system; and
(e) if the system is not in motion,
(i) removing power from said accelerometers;
(ii) delaying a period of time; and
(iii) repeating steps (a)-(e).

34. The navigation system of claim 25 wherein said data link further comprises a radio frequency transceiver configured for the wireless transmission and reception of digital information.

35. The navigation system of claim 34 wherein said radio frequency transceiver is further configured to communicate with a satellite.

36. The navigation system of claim 35 wherein said satellite is part of a network of communication satellites.

37. The navigation system of claim 19 wherein said computing device includes database information selected from the group consisting of:
(a) 2-D map information;
(b) topographical information; and
(c) oceanographic information,

38. The navigation system of claim 19 further comprising a memory card.

39. The navigation system of claim 38 further including at least one protectant for said memory card selected from the group consisting of:
(a) inertia absorbing material;
(b) heat insulating material; and
(c) corrosion resistant conformal coating.

40. A ground collision avoidance system for use at an airport to prevent incursions between aircraft, vehicles, people, and objects comprising:
a navigation system including a MEMS based inertial measurement unit, said navigation system portable and used to provide a position of an aircraft, a vehicle, a person, or in immediate proximity of an object;
a transmitter for transmitting said position of said aircraft, said vehicle, said person, or said object;
a receiver for receiving a position of other nearby ground collision avoidance systems; and
a display for displaying said position of nearby aircraft relative to the position of said aircraft, said vehicle, said person, or said object.

41. The ground collision avoidance system of claim 40 wherein each aircraft, vehicle, person, and object which transmits a position has a unique identifier and said unique identifier is included in each transmission.

42. The ground collision avoidance system of claim 41 further comprising a brake sensor and wherein said transmitter transmits said brake sensor data.

43. The ground collision avoidance system of claim 41 further comprising a thrust sensor and wherein said transmitter transmits engine thrust data.

44. The ground collision avoidance system of claim 40 further comprising an interface, said interface for communication with a flight data recorder.

45. The ground collision avoidance system of claim 40 wherein said navigation system further provides a heading of said aircraft, said vehicle, or said person and wherein said transceiver transmits said heading.

46. The ground collision avoidance system of claim 40 wherein said system is portable to be moved from said aircraft, said vehicle, said person, or said object to another aircraft, vehicle, person, or object.

47. An air traffic control system comprising:
an aircraft in the vicinity of the air traffic control system;
a navigation system on board said aircraft for providing a position of said aircraft, said navigation system including a MEMS based inertial measurement unit;
a transmitter on board said aircraft configured to transmit said position;
an air traffic control facility configured to receive and display said position of said aircraft to an air traffic controller.

48. An integrated flight data recorder and navigation system comprising:
a navigation system for providing aircraft navigational parameters;
a nonvolatile memory device for recording and archiving said navigational parameters,
wherein said navigation system and said nonvolatile memory are integrated into a single housing.

49. The integrated flight data recorder and navigation system of claim 48 further comprising a plurality of inputs for receiving information from other aircraft systems, wherein said information is stored in said nonvolatile memory.

50. The integrated flight data recorder and navigation system of claim 49 further comprising:
a transmitter in communication with said navigation system such that a portion of said navigational parameters and said information are transmitted to a ground based station.

51. The integrated flight data recorder and navigational system of claim 50 wherein said central ground station includes a processor for analyzing said navigational parameters and said information and said navigational parameters and said information are adequate to allow the prediction of a crash site in the event of a crash.

52. The integrated flight data recorder and navigation system of claim 50 wherein said navigational parameters and said information comprise the information recorded in said nonvolatile memory.

53. The integrated flight data recorder and navigation system of claim 48 wherein the integrated flight data recorder and navigation system is portable.

54. A ground incursion system, comprising:
a plurality of craft, each of said craft equipped with:
a navigation system which provides a position of said craft; and
a transmitter for configured to transmit said position; and
an accelerometer in at least one of the craft for sensing movement of said craft, said accelerometer having an output providing a signal indicative of movement of said craft and including said signal in said transmission; and
a central station comprising:
a receiver for receiving said position and said movement from said craft; and
a processor for evaluating the movements of each craft of said plurality of craft and predicting collisions between two or more craft of said plurality of craft.

55. A low-cost navigation system comprising:
a magnetometer for measuring one or more independent components of the earth's magnetic field, said magnetometer having an output providing a signal indicative of the earth's magnetic field; and
a means for inputting a position on the earth's surface; and
a computing device comprising:
an input for receiving said output; and
a database of the earth's magnetic field,
wherein the attitude of navigation system may be determined by comparing said position, and the direction of the earth's magnetic field, with information contained in said database.

56. The low-cost navigation system of claim 55 wherein said means for inputting a position on the earth's surface comprises a GPS receiver for determining the position of the navigation system and wherein said database is structured such that the stored direction of the earth's magnetic field is arranged relative to discrete positions on the earth's surface.

57. A method for determining the attitude of a craft comprising:
(a) affixing a magnetometer to the craft such that the direction of the earth's magnetic field may be measured relative to an axis of said craft;
(b) providing a database of the earth's magnetic field relative to positions on the earth's surface;
(c) providing a positioning system for indicating the position of the craft;
(d) obtaining a position of the craft from said positioning system;
(e) obtaining the direction of the earth's magnetic field relative to the craft from said magnetometer;
(f) finding the direction of the earth's magnetic field from said database at said position obtained in step (d); and
(g) finding the difference between said direction of earth's magnetic field relative to the craft obtained in step (e) and the direction of the earth's magnetic field found in said database in step (f).

58. A method for managing the electrical power of a navigation system when the navigation system is in a power-conserving mode including the steps of:
(a) providing a positioning system for indicating the position of said system;
(b) providing a motion sensor system for indicating movement;
(c) applying power to said motion sensor;
(b) reading the movement of the system from said motion sensor;
(c) determining if said system is in motion;
(d) if the system is in motion,
(i) terminating the power conserving mode; and
(i)(i) applying power to the remaining circuitry of the navigation system; and
(e) if the system is not in motion,
(i) removing power from said motion sensor;
(ii) delaying a period of time; and
(iii) repeating steps (a)-(e).

59. An air traffic warning system comprising:
an aircraft in the vicinity of an air traffic control system;
a receiver on board said aircraft configured for the wireless reception of digital information;
a transmitter linked to an air traffic control facility configured for the wireless transmission of digital information.
wherein a predetermined message is provided on said aircraft upon receipt of a particular code sent from said air traffic control facility via wireless transmission means.
